(19) United States
(12) Patent Application Publication
(10) Pub. No.: US 2015/0084590 A1
(43) Pub. Date: Mar. 26, 2015

(54) MULTI-CELLULAR CHARGING STATION FOR ELECTRONIC DEVICES AND METHOD OF USE

(71) Applicant: Adam Sidney Pearlman, Orlando, FL (US)

(72) Inventor: Adam Sidney Pearlman, Orlando, FL (US)

(21) Appl. No.: 14/036,349

(22) Filed: Sep. 25, 2013

(51) Int. Cl. H02J 7/00

(52) U.S. Cl. CPC H02J 7/0027
USPC 320/111; 320/137

(57) ABSTRACT

A new and useful multi-cellular charging station for electronic devices which provides public access to electrical power for the purpose of charging electronic devices such as mobile phones, is secure, accepts payment, and is configurable. Typical situations and settings that would benefit from the availability of such an invention would be tourist areas, bars, lounges, lobbies and other spaces frequented by the public. The apparatus essentially comprises a plurality of locking cells, with a charging means in each. Said cells can be adjoined in a variety of configurations. The invention can further comprise an enclosure and centralized payment means.

### TECHNICAL FIELD

The present invention is in the technical field of charging stations. More particularly, the present invention is in the technical field of charging stations for electronic devices. More particularly, the present invention is in the technical field of multi-cellular charging stations for electronic devices.

### BACKGROUND OF THE INVENTION

The use of portable electronic devices is ubiquitous in modern society. Cellular phones, tablet computers, music and global positioning devices are used on a daily basis by most Americans for a variety of purposes. These purposes expand beyond productivity and can include games, and communication. Therefore it is common to see the devices being carried an used by persons in most public settings. However, in most public settings convenient means to power and charge the devices are rare. It has even become common for coffee houses and other establishments to actually block or cover once existing electrical outlets. The most often cited reason by these businesses is the desire to curb loitering and minimize excess energy cost related to charging devices. For this reason, a market has developed for an alternative to facilitate charging of devices in public spaces.

In the applicant's experience there is a deficiency in the existing and prior art wherein there are no charging stations for public use that are secure and provide a payment means for the service. In the applicant's experience it is all too common in the public environment, specifically a bar or food establishment, where the patrons actively seek and inquire about charging means for their devices. Often times, these patrons are far from their personal chargers, and ask the bartender or other staff to allow them access to an electrical outlet or charging means behind the bar or other location. Sometimes patrons even ask to borrow the use of the charging apparatus of an employee of the establishment.

It is of course highly discouraged and disfavored to provide this service to the client. If in the instance a patron's electronic device is charged behind the bar, the device is exposed to often wet conditions. Spillage of food and drink around the prep area endangers the electronics of the device. Further, employees and establishments do not want to take on the liability of loss or damaged property. Theft is also an issue.

In the applicant's experience, there is a need for a multi-cellular charging station for electronic devices which has the properties of i) providing public access to electrical power for the purpose of charging electronic devices such as mobile phones, ii) is secure, iii) accepts payment, and iv) is configurable. The device of the present invention is believed to accomplish all of the foregoing objectives.

### SUMMARY OF THE INVENTION

The present invention provides a new and useful multi-cellular charging station for electronic devices which provides public access to electrical power for the purpose of charging electronic devices such as mobile phones, is secure, accepts payment, and is configurable. The invention is believed to be useful in settings such as tourist areas, bars, lounges, lobbies and other spaces frequented by the public.

In one of its basic embodiments, the present invention comprises a plurality of cells that are generally cubic in shape and have a hull with an interior compartment within. An aperture is present on the front side of the hull and connects via a hinging means to a door of a size and shape that corresponds to the aperture. The door further comprises an integrated locking means, which can be a mechanical lock and key; When the door is closed and the lock engaged, a seal is created thereby securing any contents within the interior compartment.

Also, a plurality of charging means is present inside the interior compartment. Said charging means can be charging cables for electronic devices, a power strip, extension cord or an electrical outlet. This charging means is also connected to a powering means which provides electrical power to the charging means and attached electronic devices. The powering means also comprise at least one standard electrical plug for connecting the charging station to an electrical outlet in the environment.

Each cell can be attached to another and thereby be configured according to the needs of the environment. Each cell is attached by at least one attaching point with connecting means such as screws or rivets. This feature allows the invention to be configured and comprise any number of individual cells or shape according to the needs of the environment.

In another embodiment of the present invention the cells can be housed in an enclosure. The enclosure can be utilized to attach the cells to a wall, or optionally the floor by implementation of a pedestal.

In another embodiment of the present invention, a centralized payment system is integrated to accept payment from users. The centralized payment system can be mechanical or electronic. Said payment can be cash, credit or other means like tokens.

When the device is in use, the user presents herself with an electronic device in her possession. The user selects the electronic device that requires charging and then finds an available cell in the charging station. The user then opens the door on the available cell and thereby exposes the interior compartment and the charging means therein.

Next, the user attaches the electronic device to the corresponding charging means and confirms that the electronic device is charging. The user then places the electronic device inside the interior compartment of the cell and closes the door.

Optionally, the user may lock the cell by utilizing a locking mechanism that is integrated in the cell door, if present.

After waiting for the electronic device to complete the desired charging cycle, the user retrieves the electronic device by opening the door of the cell, detaches the electronic device from the charging means, and removes the electronic device from the interior compartment. Finally the user closes the door of the cell.

In any of the embodiments of the present invention, the user may be required to pay for access and use of the charging station. Further, a timer may be integrated to limit the duration of each use.

Thus the present invention provides a new and useful multi-cellular charging station for electronic devices which provides public access to electrical power for the purpose of charging electronic devices such as mobile phones, is secure, accepts payment, and is configurable. Typical situations and settings that would benefit from the availability of such an invention would be tourist areas, bars, lounges, lobbies and other spaces frequented by the public.

Further features and objectives of the present invention will become apparent form the following detailed description and the accompanying drawings.

### BRIEF DESCRIPTION OF THE DRAWINGS

FIG. 1 is a perspective view of a cell of a multi-cellular charging station for electronic devices according to the present invention;

FIG. 2 is a perspective view of the present invention showing the interior compartment of a cell and the contents therein;

FIG. 3 is a perspective view of the present invention with multiple cells adjoined vertically;

FIG. 4 is a perspective view of the present invention with multiple cells adjoined horizontally and vertically, and enclosed with centralized mechanical payment means; and

FIG. 5 is a perspective view of the present invention with multiple cells adjoined horizontally and vertically, and enclosed with centralized electronic payment means.

### DETAILED DESCRIPTION OF THE INVENTION

As described above, the present invention provides a new and useful multi-cellular charging station for electronic devices which provides public access to electrical power for the purpose of charging electronic devices such as mobile phones, is secure, accepts payment, and is configurable. Typical situations and settings that would benefit from the availability of such an invention would be tourist areas, bars, lounges, lobbies and other spaces frequented by the public. The following description and accompanying drawings disclose at least one version of such a device.

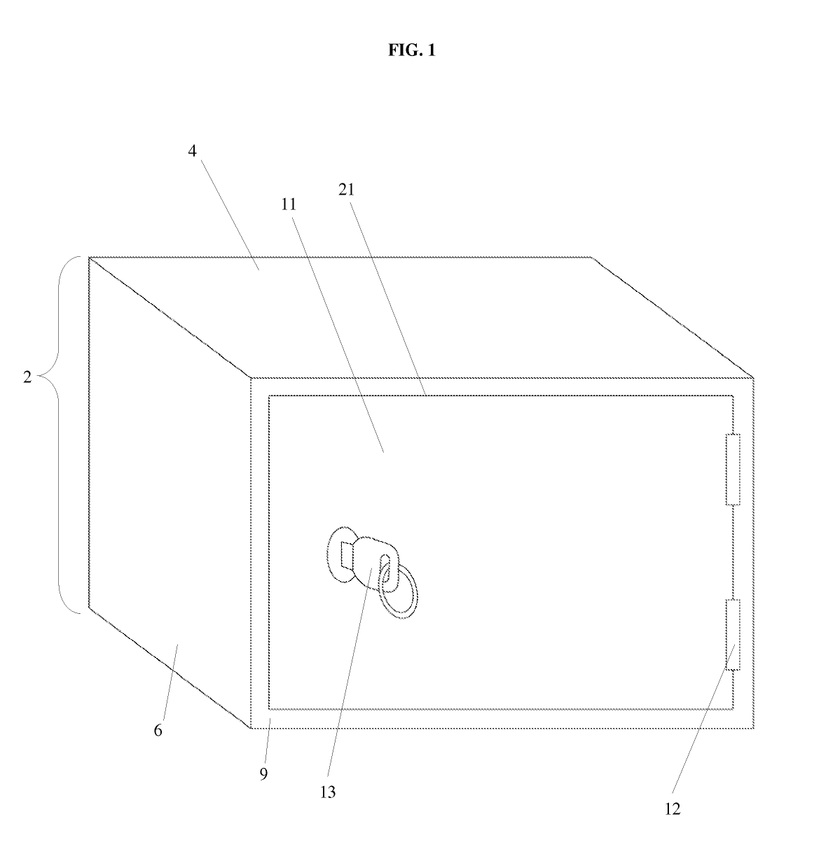

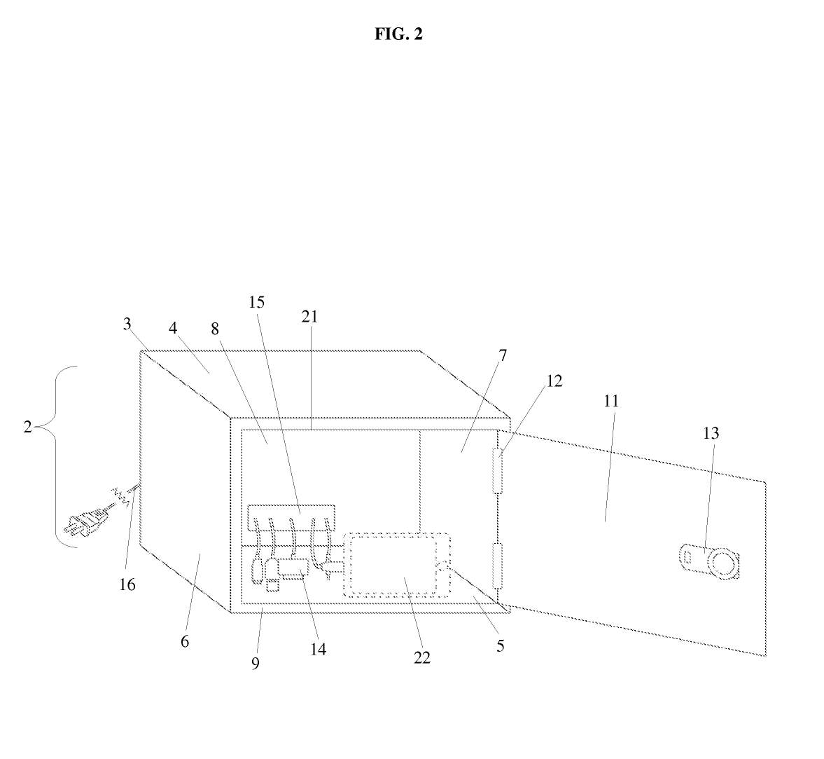

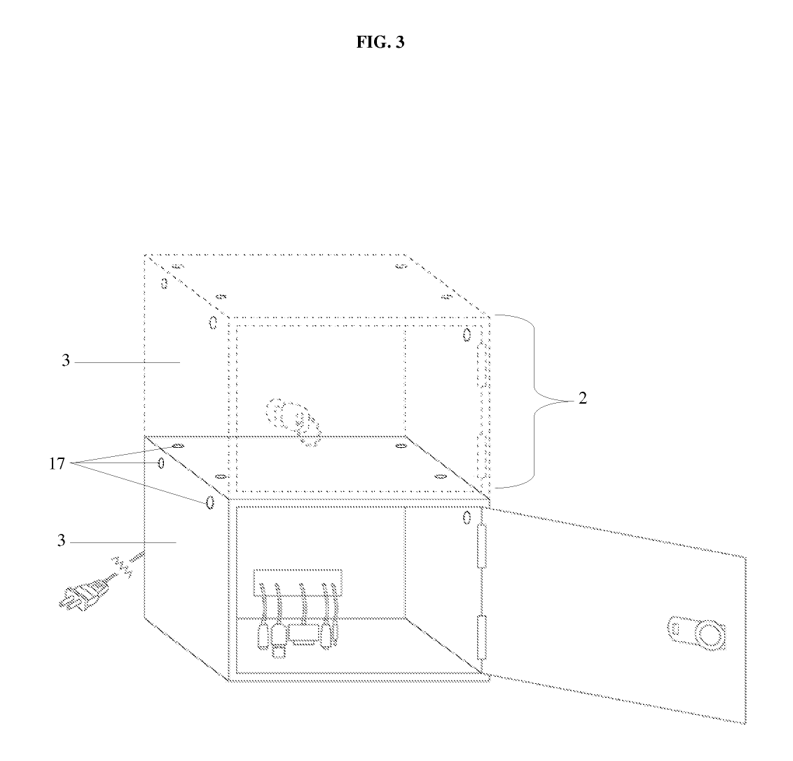

Referring now to the invention in more detail, in FIG. 1 to FIG. 5 there is shown a multi-cellular charging station for electronic devices shown generally 1 comprising a plurality of cells 2. Each cell 2 has a generally cubic hull 3 having a top side 4, bottom side 5, left side 6, right side 7, back side 8 and front side 9. Sides thereby define an interior compartment 10 within the cell 2.

The cell 2 further comprises a door 11 which can open and close and is pivotally connected to an aperture 21 in the front side 9 of the cell 2 by a hinge means 12. A locking means 13 is integrated into the door 11 and used to variably fix the door 11 to the front side 9 of the cell 2, thereby sealing the cell 2 and restricting access to the interior compartment 10 when in use. The locking means 13 can be a mechanical lock and key or an electronic lock.

Within the interior compartment of the present invention, a plurality of charging means 14 pass through at least one perforation 15 in the back side 8 of the hull 3. The charging means 14 can be charging cables for electronic devices, a power strip, an extension cord, or an electrical outlet. The charging means is selected as indicated by the desired use of the target user and environment.

A central powering means 16 is connected to the charging means 14 of the cell 2 and provides electrical power to the charging means 14. The powering means 16 has at least one standard electrical plug for connecting the charging station 1 to an electrical outlet in the environment.

The charging station 1 further comprises a plurality of attaching points 17 along the sides of the hull 3, where said attaching points 17 are utilized to optionally connect multiple cells 2 vertically and horizontally together with a connecting means such as screws or rivets.

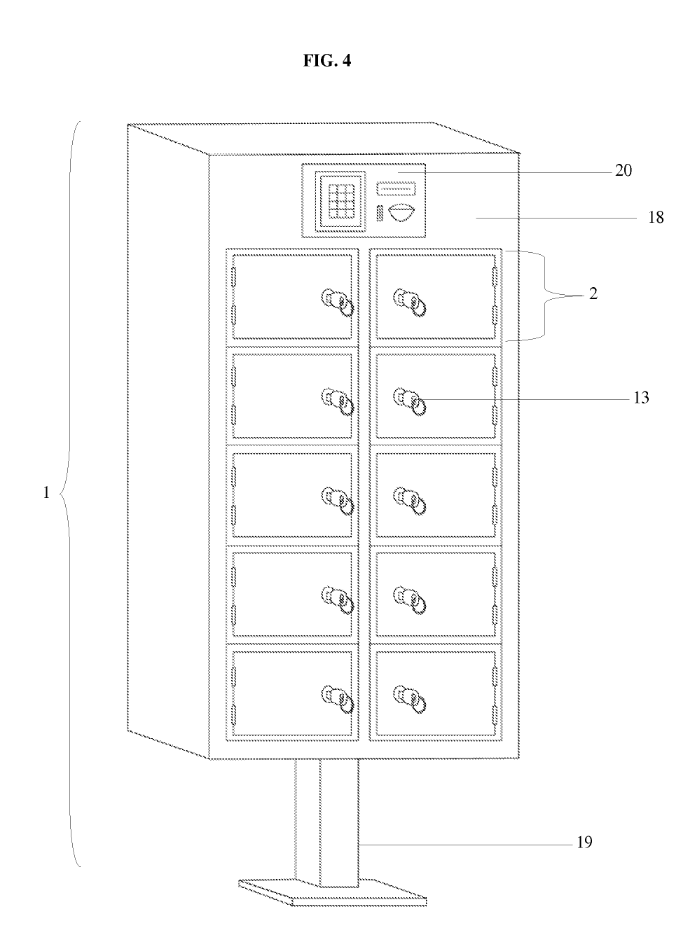

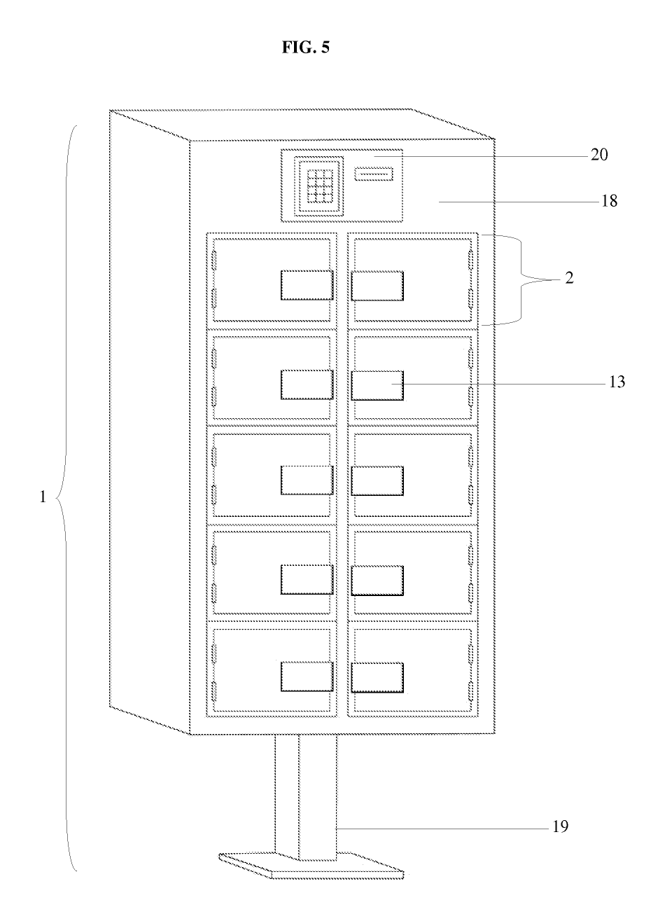

Referring to the invention in more detail in FIG. 4 and FIG. 5, the present invention is shown with multiple cells 2 adjoined horizontally and vertically and enclosed in an enclosure 18 with centralized payment means 20. The enclosure 18 that surrounds a plurality of cells 2 and allows the multi-cellular charging station to be optionally attached to a wall the environment.

In an alternate embodiment of the present invention, a pedestal 19 may be optionally attached to the enclosure 18 and allows the multi-cellular charging station 1 to stand freely in the environment and be removably attached to a floor.

In an alternate embodiment of the present invention, a centralized payment means 20 is integrated within the enclosure 18 and accepts payment from users. The payment means 20 can be mechanical and accept cash payment. In the alternative, the payment means 20 can be electronic and accept non-cash payment such as credit cards.

In an alternate embodiment of the present invention, the charging means 14 further comprises a timer to limit charging time per use.

In an alternate embodiment of the present invention, the centralized payment means 20 further comprises a timer to limit charging time per payment.

In order to utilize the present invention, the user presents herself and is desirous to charge an electronic device 22 in her possession. The user then selects the electronic device 22 that requires charging. Next the user finds an available cell 2. The user then opens the door 11 on the available cell 2 by pivoting the door 11 along the hinge means 12 axis and thereby exposes the interior compartment 10 of the cell 2 and the charging means 14 therein.

Next, the user attaches the electronic device 22 to the corresponding charging means 14 and confirms that the electronic device 22 is receiving power from the charging means 14 and is charging. The user then places the electronic device 22 inside the interior compartment 10 of the cell 2 and closes the door 11.

After waiting for the electronic device 22 to complete the desired charging cycle, the user retrieves the electronic device 22 by opening the door 11 of the cell 2. Next, the user detaches the electronic device 22 from the charging means 14 and removes the electronic device 22 from the interior compartment 10. Finally the user closes the door 11 of the cell 2.

Optionally, the user may be required to pay a fee for access and use of the present invention.

Optionally, the user may lock the door 11 of the cell 2 while the electronic device 22 is charging.

The previously described versions of the present invention have many advantages including and without limitation, the properties of i) providing public access to electrical power for the purpose of charging electronic devices such as mobile phones, ii) is secure, iii) accepts payment, and iv) is configurable. The device of the present invention is believed to accomplish all of the foregoing objectives. The invention does not require that all the advantageous features and all the advantages need to be incorporated into every embodiment of the invention.

Although the present invention has been described in considerable detail with reference to certain preferred versions thereof, other versions are possible. Therefore the spirit and scope of the appended claims should not be limited to the description of the preferred versions contained therein.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. As for “means for” elements, the applicant intends to encompass within the language any structure presently existing or developed in the future that performs the same function. The invention should therefore not be limited by the above described embodiment, method, and examples, but by all embodiments and methods within the scope and spirit of the invention.

What is claimed is:

1. A multi-cellular charging station for electronic devices comprising:
a) a plurality of cells, said cells each having a generally cubic hull having a top side, bottom side, left side, right side, back side and front side, said sides defining an interior compartment within the cell;
b) a door which can open and close and is pivotally connected to an aperture in the front side of the cell by a hinge means;
c) a locking means integrated into the door and used to variably fix the door to the front side of the cell, thereby sealing the cell and restricting access to the interior compartment when in use;
d) a plurality of charging means passing through at least one perforation in the back side of the cell hull,
said charging means can be charging cables for electronic devices, power strip, extension cord, or an electrical outlet; and
e) a central powering means connected to the charging means of the charging station, said powering means providing electrical power to the charging means, said powering means having at least one standard electrical plug for connecting the charging station to an electrical outlet in the environment.

2. The charging station as in claim 1 further comprising a plurality of attaching points along the sides of the hull, where said attaching points are utilized to optionally connect multiple cells together with a connecting means such as screws or rivets.

3. The charging station as in claim 1 further comprising an enclosure that surrounds a plurality of cells and allows the multi-cellular charging station to be optionally attached to a wall the environment.

4. The charging station as in claim 1 wherein the locking means is a mechanical lock and key.

5. The charging station as in claim 1 wherein the locking means is an electronic lock.

6. The charging station as in claim 3 further comprising a pedestal attached to the enclosure and allows the multi-cellular charging station to stand freely in the environment and be optionally attached to a floor.

7. The charging station as in claim 3 further comprising a centralized payment means within the enclosure to accept payment from users,

8. The charging station as in claim 7 wherein said payment means can be mechanical and accept cash payment.

9. The charging station as in claim 7 wherein said payment means can be electronic and accept non-cash payment such as credit cards.

10. A method of use for the charging station which comprises
a) selecting an electronic device that requires charging;
b) finding an available cell;
c) opening the door on the available cell by pivoting the door along the hinge means axis thereby exposing the interior compartment of the cell and the charging means therein;
d) attaching the electronic device to the corresponding charging means;
e) confirming that the electronic device is receiving power from the charging means and is charging;
f) placing the electronic device inside the interior compartment of the cell;
g) closing the door of the cell;
h) waiting for the electronic device to complete charging cycle;
i) opening the door of the cell;
j) detaching the electronic device from the charging means when charging is complete;
k) retrieving the electronic device from the interior compartment; and
l) closing the door of the cell.

11. The method as in claim 10 further comprising paying a fee for access to utilize the charging station

12. The method as in claim 10 further comprising locking the door while the electronic device is completing the charging cycle.

13. The charging station as in claim 1 wherein the charging means further comprises a timer to limit charging time per use.

14. The charging station as in claim 7 wherein the centralized payment means further comprises a timer to limit charging time per payment.

15. The charging station as in claim 1 wherein in the door further comprises a payment mechanism to accept payment from users.
